(19) United States
(12) Patent Application Publication
(10) Pub. No.: US 2015/0152339 A1
(43) Pub. Date: Jun. 4, 2015

(54) METHOD FOR THERMAL CONVERSION OF HETEROATOM-CONTAINING CRUDE OILS INTO LOW-HETEROATOM LIGHT AND MIDDLE OILS CONTAINING PRODUCTS PRODUCED BY THIS METHOD AND THE APPLICATION OF SUCH PRODUCTS

(71) Applicant: NEXXOIL AG, ZURICH (CH)

(72) Inventor: Thomas Willner, Hamburg (DE)

(73) Assignee: NEXXOIL AG, ZURICH (CH)

(21) Appl. No.: 14/409,938

(22) PCT Filed: Jan. 19, 2013
(86) PCT No.: PCT/DE2013/000318

§ 371 Date: Dec. 19, 2014

(30) Foreign Application Priority Data
Jun. 20, 2012 (DE) 102012012199.7

(51) Int. Cl. C10G 31/06; C10L 1/08; B01D 3/00; C10G 3/00

(52) U.S. Cl. CPC C10G 31/06; C10G 3/40; C10L 1/08; B01D 3/00; C10L 2200/0484; C10L 2270/026; C10L 2200/0446; C10L 2290/543

(57) ABSTRACT

The invention relates to a method for the thermal conversion of heteroatom-containing crude oils into low-heteroatom light and middle oils as a product. The invention further relates to the products produced by this method and their application.

### BACKGROUND OF THE INVENTION

The invention relates to a method for the thermal conversion of heteroatom-containing crude oils into low-heteroatom light and middle oils as products. Moreover, the invention relates to the products obtained through this method and their use.

From patent publication DE 10 215679 A1 a method is known for the direct thermochemical conversion of high molecular organic substances into low viscosity fluid combustibles. However, this method didn't turn out to be successful in practice as it can't be carried out continuously and because in addition to that complex purification steps are needed when refurbishing the product.

“Heteroatoms” shall be understood herein as non-hydrocarbon atoms such as oxygen, nitrogen, sulfur, phosphor and/or halogens. According to the invention, “heteroatom-containing” refers to a certain content of organically bound heteroatoms as the initial situation in crude oil. According to the invention, “organically bound” means “bound to hydrocarbons”. According to the invention, “low-heteroatom” refers to a reduced content of heteroatoms in the product, in relation to the respective initial content in the crude oil.

According to the invention the feedstock side is defined as follows:
The term “crude oil” stands for hydrophobic and/or hydrocarbon-containing fluids.
“Hydrophobic” stands for “water-repellent” or “not miscible with water”, i.e. in contact with water always two immiscible separate fluid phases will develop, hence an oil phase and an aqueous phase, or emulsion.
Examples for heteroatom-containing crude oils are heteroatom-containing heavy oils, fats, fatty acids, fatty acid compounds, heteroatom-containing fat soluble substances, tall oils, resin acids and/or compositions of the listed substances.
Examples for heteroatom-containing heavy oils are bunker oils, oils for metalworking and/or lubricants, insofar as they contain heteroatoms.
“Fats” refers herein to all triglycerides such as vegetable oils, vegetable fats, animal oils, animal fats, algae oils and/or algae lipids.
Besides said triglycerides examples for fatty acid compounds are fatty acid esters, monoglycerides, diglycerides, phosphatides, glycolipids, diol lipids, waxes and/or sterol esters.
Examples for heteroatom-containing fat soluble substances are sterols, respectively steroid alcohols, tocopherols, tocotrienols and/or colorants such as chlorophyll.

According to the invention the product side is defined as follows:
As products of the method according to the invention low-heteroatom light and/or middle oils and a non-condensing gas phase are generated. Furthermore an aqueous phase and/or a solid residue may be generated.
Low-heteroatom light and/or middle oils shall be understood as hydrocarbon-rich organic fluids that evaporate under reaction conditions and have a lower heteroatom content, respectively, than the respective used crude oils.
Typical carbon chain lengths for light oils are in the range of C5 to C10 and for middle oils in the range of C11 to C25.
Examples for application fields of the product oils are their use as
   heating oil additive components,
   heating oil substitute,
   additive components and/or additives of fuels such as gasoline, diesel and/or kerosene,
   substitute of fuels such as gasoline, diesel and/or kerosene,
   intermediate products for the preparation of fuel components and/or fuel substitute through procedural measures such as hydrogenation and/or deoxygenation,
   and/or as platform chemicals for the chemical and/or pharmaceutical production.

### SUMMARY OF THE INVENTION

The basic idea of the invention can be explained with the example of fats, respectively triglycerides. In trying to use these raw materials as petroleum substitute for example in the fuel field, in this case in particular as diesel additive component or as diesel substitute, one is confronted with a number of problems and disadvantages.

First, fats display a too high viscosity in comparison with diesel which leads to problems with the injection and the combustion in the motor. Second, because of their relatively high oxygen content of ca. 11 wt. % they have a lower energy content than diesel. The calorific value of diesel is ca. 42.5 MJ/kg while fats such as rapeseed oil only have a calorific value of ca. 37 MJ/kg. Finally, fats have a worse cold stability than diesel, i.e. they coagulate at low temperatures as for example in winter.

The conversion of fats into fatty acid methyl esters, the so-called biodiesel, indeed reduces the viscosity nearly to the level of diesel, but it changes neither the high oxygen content and the low calorific value nor the unsatisfactory cold stability. Moreover, it generates new problems by undesired product characteristics such as aggressive solution properties, unfavorable lubricant interactions and an unfavorable evaporation behavior in the motor because of a too uniform chain length distribution of the molecule typically in the C19 range, in contrast to a broad chain length distribution of a diesel between C10 and C25. All that leads to a very limited tolerance for biodiesel as an additive to diesel fuel. In Germany the permitted upper limit for biodiesel content is only 7%.

Recent developments try to solve the problems through thermochemical conversion methods in which the oxygen content of the fats is reduced or even eliminated and in which a broad chain length distribution is generated so that finally products can be achieved that may be added to diesel fuel to a higher or even to an unlimited degree. Here two methods shall be mentioned that are revealed in documents EP 1 489 157 and EP 1 396 531. These two methods solve the problems of viscosity lowering, oxygen reduction, cold stability improvement, generation of a broad chain length distribution in the diesel range as well as an increase of the permitted additive content in diesel fuel. But both methods need expensive catalysts for the conversion process that are going to be consumed over time or will be deactivated, and moreover, they require augmented purification efforts on the crude oil side for removing contaminations that may act as catalyst poisons.

In the case of EP 1 489 157 activated carbon is used as a catalyst. This is exacerbated by the fact that the crude oil shall be transported through the catalyst bed by means of a stream of inert carrier gas. For this purpose the crude oil has to be evaporated first which, as is generally known, requires in the case of fats very high temperatures in the range of 500° C., wherein already in the heating phase of the raw material uncontrolled decomposition reactions start even before this evaporating temperature is reached. Another disadvantage is that after the product separation the stream of inert gas is fed again into the reactor via an internal circuit. This requires larger dimensions of the reactor and for the ensuing deposition fractions, consisting mainly of condensers. It is further known that increasing portions of inert gas have an increasingly negative effect on the heat transfer in condensers, whereby their dimensions further increase strongly. Moreover, an additional gas processing step is needed for separating the combustible fractions from the incombustibles because otherwise the combustible fractions can't be used as fuel gas for the energy supply because of the diluting effect from the inert gas portions. All that augments the investment costs. Further, it increases also the operating costs because the circuit gas portion increases the cooling effort in the condensers as well as the heating effort for the preheating before entering the reactor and it requires further said additional processing step.

In the case of EP 1 396 531 metal catalysts are used that are particularly sensitive to catalyst poisons. This is exacerbated by the fact that expensive compressed hydrogen is needed for the hydrodeoxygenation aspirated in this method. In consequence increased process pressures between 50 and 100 bar are required. The high hydrogen consumption as well as the augmented pressure additionally increase the catalyst costs.

This discussion shows that there is a demand for optimization of methods for the conversion of crude oils into high-quality hydrocarbon-rich product oils. The invention solves the mentioned problems in a surprising and simple way. The method according to the invention provides that a thermic crude oil conversion is performed in a stabilized sump phase. Surprisingly, it can be thus achieved to reach the aspirated crude oil conversion cost-effectively without the use of catalysts, hydrogen or streams of inert gas.

The method according to the invention comprises the following steps to be performed:
Introducing the raw material into a reactor in which a sump phase is held at reaction temperature. In the sump phase the conversion reactions take place.
Evaporating the target products in the light and/or middle oil range from the sump phase and conducting them out of the reactor through the released gas/vapor phase. Herein “gas” means the non-condensable portions and “vapor” the condensable portions.
Cooling of the released gas/vapor phase, condensing of the vapor portions, depositing and conducting out of the formed condensate.
Discharging the non-condensed gas phase.

In FIG. 1 the method according to the invention is shown in the form of a block flow chart.

The condensate is fluid and according to the invention consists of at least one oil phase containing the target products in the light and/or middle oil range. In cases in which the crude oil contains at least oxygen as heteroatom additionally to the oil phase an aqueous phase, also called water phase, is formed as a second condensate phase that is immiscible and separated from the oil phase.

The method according to the invention can be carried out in a continuous operation mode characterized by a permanent raw material supply and a permanent product outlet. The continuous operation may be interrupted, however, from time to time for exchanging and/or cleaning the sump phase.

Normally, the method according to the invention can be carried out under atmospheric pressure. In some cases described further below increased or reduced pressures are recommendable or needed. The required reaction temperatures are moderate and lie in the range between 200° C. and 470° C., preferred between 300° C. and 440° C., particularly preferred between 350° C. and 410° C. These comparatively low temperatures are particularly surprising in the light that no catalysts are used. Perhaps autocatalytic effects occur at this method according to the invention.

The density of the occasionally occurring aqueous phase as described above is normally higher than the density of the oil phase in the condensate so that the aqueous phase normally gathers at the bottom of the condensate separator and the oil phase lies above. In a few cases in which the product oils are aromatic rich for example it can be reverse.

The discharge gas phase is another product generated during the conversion reactions in the reactor and released from the sump phase. The gas phase diverted at the end is combustible and can be used for example for the energy supply of the processor or can be conducted to other applications.

“Sump phase” means according to the invention a heavy oil phase that is fluid but does not evaporate under reaction conditions.

Surprisingly, it was found that the sump phase is self-stabilizing during continuous operation according to the invention. A “stabilized sump phase” as reaction medium according to the invention is characterized by the following features:
The sump phase regenerates, i.e. is renewed, independently during continuous operation according to the invention.
The characteristics of the sump phase and/or the characteristics of the products evaporating from it and/or the characteristics of the released products do not change during continuous operation according to the invention.

Particularly surprising is the inventively revealed fact that such stabilized sump phases exist at all during a continuous operation according to the invention or can be generated through the conversion process. Unexpectedly it was found during continuous operation according to the invention that the provided sump phase in the reactor shifts towards a steady state in which the characteristics of the sump phase and/or the characteristics of the products evaporating from it or being released from it eventually don't change anymore. Surprisingly, the sump phase regenerates itself after reaching this steady state via intermediate products generated during the raw material conversion.

Surprisingly, it was found that the method according to the invention leads to a large or sometimes even complete suppression of the formation of solid residues. In the cases in which some portions of solid residues are formed in the reactor according to the invention a portion of the sump phase is transferred out during the continuous operation and delivered from the residue by means of a solid-liquid separation. Optionally, the cleaned sump phase can be reverted as sump oil into the reactor, or it can be conducted to other applications such as energetic or material use. As an alternative to the out-transfer of portions of the sump phase the entire sump phase can be evacuated after interrupting the continuous operation and can be delivered from the residue by means of a solid-liquid separation. In this case the cleaned sump phase can be reverted into the reactor and, if necessary, it can be supplemented by new sump phase and/or it can be substituted by a new starter sump phase, as described below. Applicable solid-liquid separations are for example filtration, centrifugal separation, gravity separation, vacuum distillation and/or solvent extraction.

For initiating a process according to the invention a heavy oil that does not evaporate under reaction conditions and that is miscible with the respective crude oil to be processed, and/or the respective crude oil itself, is provided as a starter sump phase in the reactor, it is heated to the reaction temperature and the method steps according to the invention as outlined above are carried out. Heavy oils applicable for this process are for example long chain hydrocarbons and/or heteroatom-containing long chain hydrocarbons.

In cases in which the sump phase tends for example towards polymerization and/or the formation of a solid residue the performance of the method according to the invention can be achieved for example by interrupting the continuous operation from time to time as is needed for exchanging and/or cleaning the sump phase. But also in the aspirated continuous operation mode without interruption the inventive formation and/or maintenance of a stabilized sump phase can be surprisingly achieved by simple procedural means such as increasing or reducing the temperature, a permanent out-transfer of portions of the sump phase, the addition of polymerization inhibitors, the addition of carbonization inhibitors and/or increasing or reducing of the pressure. Suitable polymerization inhibitors and/or carbonization inhibitors are for example radical scavengers.

The simple procedural means of increasing or reducing the operative pressure the atmospheric pressure can surprisingly also be helpful when the product characteristics shall be changed, optimized and/or accommodated to requirements. If the product spectrum shall be shifted for example towards longer chained oils this can surprisingly be achieved by reducing the pressure. This means of reducing the pressure can for example also be indicated if the crude oil to be processed is thermally very instable, i.e. it decomposes already at comparatively low temperatures. If shorter chained oils are desired in reverse a pressure increase can yield this result.

In case of volatile crude oils such as numerous fatty acids that evaporate already before reaching the required reaction temperature the inventive operation mode can surprisingly be achieved also by simple procedural means. One option is for example to add stabilizers to the crude oil that ensure that the mixture does not evaporate at reaction temperature. As stabilizers may serve for example long chain hydrocarbons and/or heteroatom-containing long chain hydrocarbons if they meet the inventive requirements to be miscible with the crude oil and not to evaporate under reaction conditions. A further means in case of such volatile crude oils can be as an alternative to the addition of stabilizers or in combination with the addition of stabilizers the increase of the operative pressure for enabling the inventive formation and/or maintenance of a stabilized sump phase when performing the method steps according to the invention. Normally, already a mild pressure increase to 1.5 to 5 bar is sufficient. Occasionally, as for example in the case of shorter chained fatty acids, higher operational pressures up to 20 bar or in rare cases up to 100 bar are needed.

The inventive cooling of the gas/vapor mixture discharged of the reactor including the condensation of the vapor portion as well as the separation and discharge of the condensate can be carried out in two or more stages. Herein a certain temperature below the respective reaction temperature, i.e. the reactor temperature, is set in such a way that temperatures decrease stepwise from stage to stage. This means that the first stage is run at the highest temperature and the last stage at the lowest temperature, but also the temperature of the first stage already lies below the reaction temperature. During each stage a part of the vapor portion is condensed herein and discharged, wherein the respective residual gas/vapor phase of each stage is forwarded into the respective next stage. During the last stage the residual vapor portion in the gas/vapor phase is condensed and discharged and then the remaining gas phase is discharged. In general this is achieved by setting the temperature of the last phase at 20° C., but if necessary it can be also run at lower temperatures until the aim of a complete condensation of the residual vapor portions is achieved in the last stage. Using a multi-step cooling and condensation, as described herein, a separation of the product oil portions in the condensate into separate boiling fractions is achieved. By this fractionation of the product oil in the light and/or middle oil range a better accommodation of the product properties to the desired product applications, as described above, can be achieved and the effort of product fractionation can be reduced by posterior distillation or rectification.

Surprisingly, it was found that the product characteristics can be improved in respect of lowering the heteroatom portion when the two- or multi-stage cooling and condensation described herein is carried out and the condensate of one and/or more stages is completely or partially reverted into the reactor.

Despite the simplicity of the method the product qualities achieved according to the invention are surprisingly good. Though no catalysts and no compressed hydrogen are used there is a surprisingly strong reduction in heteroatom portions that is accompanied by a significant increase in the calorific value. The viscosity is clearly reduced, often to the level of a conventional diesel fuel, and the cold stability is clearly improved. Furthermore, the desired broad molecule chain length distribution in the light and/or middle oil range is achieved according to the invention despite the comparatively low reaction temperatures.

The generated product oils can be used among others in all fields of use lined out above in the product definition. This may occur or immediately without further processing of the obtained oil according to the invention, or after further processing. Suitable processing means for improving the product quality are conventional refining processes, hydrogenation and/or deoxygenation. For example, distillation and rectification for the production of defined boiling fractions can be used as refining processes that are for example needed for certain fuel products such as gasoline, diesel or kerosene.

### BRIEF DESCRIPTION OF THE DRAWINGS

FIG. 1 shows a block flow chart of the claimed method invention.

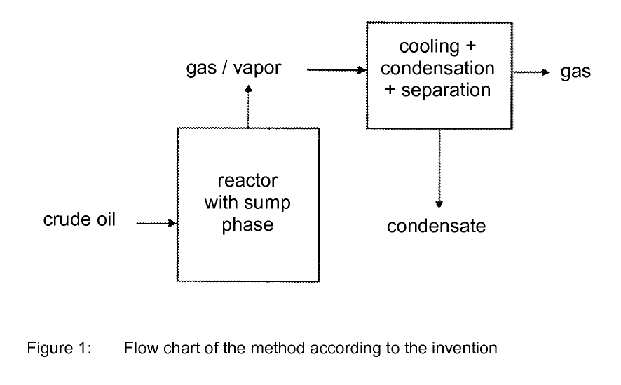

FIG. 2 shows the GC/MS analysis of the product oil.

### DETAILED DESCRIPTION OF THE INVENTION

A further advantageous feature of the method according to the invention is its surprising flexibility in respect of applicability to the most variable crude oils that are listed above under the definition of the term “crude oil”. A further advantage is the lack of sensitivity of the method according to the invention in respect of contaminations in the crude oil, as for example in the method according to the invention no catalysts are used so that for example catalyst poisons don't play a role. Hence it is even possible to utilize used crude oils such as waste oils, used bunker oils, used frying oils, fats from fat separators and/or many other residual oils.

In particular in respect of the patent publication DE10215679A1 mentioned before surprising advantages of the inventive method according to the invention become evident: In the method known from the state-of-the-art no self-stabilizing sump phase according to the present application is described. The self-stabilizing sump phase according to the present application forms a steady state in which optimally neither the characteristics of the sump phase nor the characteristics of the released products are changed. The method described in the state-of-the-art (DE10215679A1) leads to a change in the characteristics of the sump phase and in particular to that the reactor gets “stuck” after a certain period of time. This should be attributed in particular to the solid portions and also to other components. Because of this reason the separation of the different phases is extensively described in DE10215679A1. In particular in paragraphs 33-34 the complex separation process is described that shall cause a prolongation of the operational duration. So far as Applicant knows the measures described therein are not sufficient to enable a really continuous operation. In the method according to DE10215679A1 the reactor has to be run down at regular intervals for enabling an exchange of the sump phase.

In contrast, the inventive method according to the invention displays other characteristics: After a short starting phase of the reactor the sump phase stabilizes itself independently so that only in extreme cases an exchange or a cleaning of the sump phase is required. In general, a continuous operation can be performed.

### Examples

The invention shall be explained closer by means of the following three embodiments in which the method according to the invention is experimentally applied to three different crude oils, under atmospheric pressure respectively

### Experimental Embodiment 1

### Refined Rapeseed Oil

In experimental embodiment 1 refined rapeseed oil is used as crude oil. First, 8 kg of this crude oil are provided as a starter sump phase in a laboratory reactor and are heated up to a reaction temperature of 370° C. After reaching the reaction temperature the continuous supply of 1 kg/h crude oil starts. Because of the conversion reactions in the sump phase the product oil in the light and middle oil range, water and a combustible gas are generated. The product oil and the water evaporate in the reactor and together with the generated gas they are continuously conducted out of the superior part of the reactor via the gas/vapor phase. This gas/vapor phase is led over two cooling stages. The first stage is held at 250° C. and the second at 20° C. In the first stage a portion of the vapor phase condensates and the generated condensate, consisting of an oil in the upper middle oil range, is separated and completely and continuously reverted into the reactor. In the second stage the rest of the vapor portions is condensed. The condensate of the second stage, consisting of the product oil in the light and middle oil range and an aqueous phase, is separated and continuously discharged. The separated condensate consists of two immiscible fluid phases one above the other, wherein the product oil phase forms the superior phase because of lower density and the aqueous phase forms the inferior phase because of higher density. The non-condensed gas remaining after the second stage is continuously discharged. In the course of the continuous operation the reaction temperature is readjusted in such a way that the permanently monitored sump phase amount is kept constant in the reactor. This leads to a gradual increase in the reaction temperature up to 374° C. until after some time the stationary, i.e. temporally constant operation mode is reached in which neither the characteristics of the condensed and discharged product oil nor the temperature changes. In total, the continuous operation mode is maintained over 50 hours. Then the experiment is terminated by stopping the crude oil supply and at the same time the reactor is cooled so that because of the dropping temperature no conversion reactions occur anymore. In the end the reactor is emptied.

The evaluation of the experiment yielded the following mass balance:

In addition to the initial charging 50 kg crude oil are continuously led into the reactor. The sump phase amount stays constant at 8 kg including a small amount of solid residue of 0.1 kg that was formed in the course of the experiment in the sump phase. The amount of the collected product oil is 40.2 kg, the amount of the aqueous phase 2.5 kg and the gas amount calculated by difference is 7.3 kg.

Analyses Yielded the Following Data:

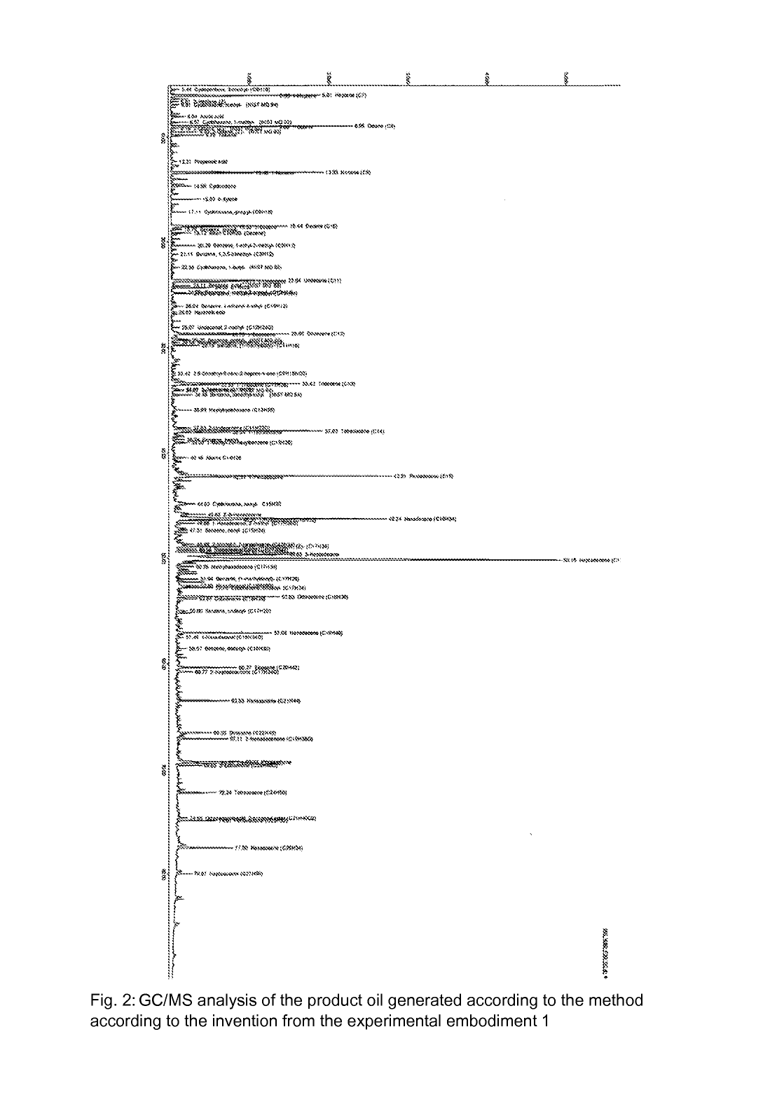

The crude oil has an oxygen content of 10.9 wt. % and an inferior calorific value of 37.1 MJ/kg. The product oil has 4.5 wt. % oxygen, an inferior calorific value of 40.9 MJ/kg, a density of 842.5 kg/m³, a viscosity of 3.6 mm²/s at 40° C., acetane number of 61.5, an initial boiling point of 81° C. and a final boiling point of 373° C. The GC/MS analysis of the product oil is shown in FIG. 2. There it can be seen that predominantly saturated and unbranched alkanes and to a lower degree alkenes have been generated. Fatty acids and fatty acid derivatives are mostly pushed back. In total, the analysis data confirm that the product oil lies in the light and middle oil range.

Product oil application tests in a diesel motor show that the product oil is suitable as a diesel substitute and also as an additive component, respectively an additive of conventional diesel fuel. Already comparatively small additive amounts of 5 vol. % product oil in conventional diesel fuel show an advantageous emission-reducing effect. In comparison with motor operation with a purely conventional diesel the operation with 5 vol. % product oil in the diesel fuel shows a relative reduction of NOₓ emission by 5% to 20% and of uncombusted hydrocarbons by 50% to 70%.

### Experimental Embodiment 2

### Used Fat

In experimental embodiment 2 old fat is used. The old fat comes mainly from the gastronomy sector. It is only roughly mechanically purified through filtration and then used as crude oil in the method according to the invention. First, 8 kg of this crude oil are provided as a starter sump phase in a laboratory reactor and are heated up to a reaction temperature of 365° C. After reaching the reaction temperature the continuous supply of 1 kg/h crude oil starts. Because of the conversion reactions in the sump phase the product oil in the light and middle oil range, water and a combustible gas are generated. The product oil and the water evaporate in the reactor and together with the generated gas they are continuously conducted out of the superior part of the reactor via the gas/vapor phase. This gas/vapor phase is led over two cooling stages. The first stage is held at 250° C. and the second at 20° C. In the first stage a portion of the vapor phase condensates and the generated condensate, consisting of an oil in the upper middle oil range, is separated and completely and continuously reverted into the reactor. In the second stage the rest of the vapor portions is condensed. The condensate of the second stage, consisting of the product oil in the light and middle oil range and an aqueous phase, is separated and continuously discharged. The separated condensate consists of two immiscible fluid phases one above the other, wherein the product oil phase forms the superior phase because of lower density and the aqueous phase forms the inferior phase because of higher density. The non-condensed gas remaining after the second stage is continuously discharged. In the course of the continuous operation the reaction temperature is readjusted in such a way that the permanently monitored sump phase amount is kept constant in the reactor. This leads to a gradual increase in the reaction temperature up to 369° C. until after some time the stationary, i.e. temporally constant operation mode is reached in which neither the characteristics of the condensed and diverted product oil nor the temperature changes. In total, the continuous operation mode is maintained over 50 hours. Then the experiment is terminated by stopping the crude oil supply and at the same time the reactor is cooled so that because of the dropping temperature no conversion reactions occur anymore. In the end the reactor is emptied.

The evaluation of the experiment yielded the following mass balance:

In addition to the initial charging 50 kg crude oil are continuously led into the reactor. The sump phase amount stays constant at 8 kg including a small amount of solid residue of 0.3 kg that was formed in the course of the experiment in the sump phase. The amount of the collected product oil is 39.5 kg, the amount of the aqueous phase 2.7 kg and the gas amount calculated by difference is 7.8 kg.

Analyses Yielded the Following Data:

The crude oil has an oxygen content of 11.2 wt. % and an inferior calorific value of 36.8 MJ/kg. The product oil has 4.9 wt. % oxygen, an inferior calorific value of 40.6 MJ/kg, a density of 842.1 kg/m³, a viscosity of 3.5 mm²/s at 40° C., an initial boiling point of 76° C. and a final boiling point of 370° C. In total, the analysis data confirm that the product oil lies in the light and middle oil range.

### Experimental Embodiment 3

### Used Bunker Oil

In experimental embodiment 3 old bunker oil is used as crude oil. First, 8 kg of this crude oil are provided as a starter sump phase in a laboratory reactor and are heated up to a reaction temperature of 395° C. After reaching the reaction temperature the continuous supply of 1 kg/h crude oil starts. Because of the conversion reactions in the sump phase the product oil in the light and middle oil range, water and a combustible gas are generated. The product oil and the water evaporate in the reactor and together with the generated gas they are continuously conducted out of the superior part of the reactor via the gas/vapor phase. This gas/vapor phase is led over two cooling stages. The first stage is held at 250° C. and the second at 20° C. In the first stage a portion of the vapor phase condensates and the generated condensate, consisting of an oil in the upper middle oil range, is separated and completely and continuously reverted into the reactor. In the second stage the rest of the vapor portions is condensed. The condensate of the second stage, consisting of the product oil in the light and middle oil range and an aqueous phase, is separated and continuously discharged. The separated condensate consists of two immiscible fluid phases one above the other, wherein the product oil phase forms the superior phase because of lower density and the aqueous phase forms the inferior phase because of higher density. In the course of the continuous operation the reaction temperature is readjusted in such a way that the permanently monitored sump phase amount is kept constant in the reactor. This leads to a gradual increase in the reaction temperature up to 374° C. until after some time the stationary, i.e. temporally constant operation mode is reached in which neither the characteristics of the condensed and diverted product oil nor the temperature changes. In total, the continuous operation mode is maintained over 50 hours. Then the experiment is terminated by stopping the crude oil supply and at the same time the reactor is cooled so that because of the dropping temperature no conversion reactions occur anymore. In the end the reactor is emptied.

The evaluation of the experiment yielded the following mass balance:

In addition to the initial charging 50 kg crude oil are continuously led into the reactor. The sump phase amount stays constant at 8 kg including a small amount of solid residue of 0.7 kg that was formed in the course of the experiment in the sump phase. The amount of the collected product oil is 41.4 kg, the amount of the aqueous phase 0.4 kg and the gas amount calculated by difference is 8.2 kg.

Analyses Yielded the Following Data:

The crude oil has an oxygen content of 0.95 wt. %, a sulfur content of 1.2 wt. %, a nitrogen content of 0.25 wt. %, a density of 929.1 kg/m³, a viscosity of 72.2 mm²/s and an inferior calorific value of 41.5 MJ/kg. The product oil has an oxygen content of 0.27 wt. %, a sulfur content of 0.71 wt. %, a nitrogen content of 0.10 wt. %, an inferior calorific value of 42.3 MJ/kg, a density of 858.0 kg/m³, a viscosity of 3.1 mm²/s at 40° C., an initial boiling point of 92° C. and a final boiling point of 389° C. In total, the analysis data confirm that the product oil lies in the light and middle oil range.

### Subjects of the Application:

Thus the present invention refers to the following subjects:
(I) Method for the thermal conversion of heteroatom-containing crude oils into low-heteroatom light and/or middle oils, characterized in that
   a. the crude oil is supplied into a reactor in which a sump phase is held at reaction temperature,
   b. the target products in the light and/or middle oil range evaporate from the sump phase and are discharged of the reactor via the released gas/vapor phase,
   c. the released gas/vapor phase is cooled, the vapor portions condense and the formed condensate is separated and discharged, and
   d. the non-condensed gas phase is discharged.
(II) Method according to subject I, characterized in that the method is carried out in a continuous operation mode, characterized by a permanent crude oil supply and a permanent product out-transfer.
(III) Method according to any of the previous subjects, characterized in that the formed condensate is an oil phase consisting of the target products in the light and/or middle oil range.
(IV) Method according to any of the previous subjects, characterized in that in the condensate additionally to the oil phase an aqueous phase is formed immiscibly separated from the oil phase.
(V) Method according to any of the previous subjects, characterized in that the sump phase in the reactor is a heavy oil, characterized in that at reaction temperature it is fluid and does not evaporate.
(VI) Method according to any of the previous subjects, characterized in that the sump phase is stabilized, characterized in that the characteristics of the sump phase and/or the characteristics of the products evaporated out of it and/or the characteristics of the released products don't change in the continuous operation mode.
(VII) Method according to any of the previous subjects, characterized in that the reaction temperature lies between 200″C and 470° C.
(VIII) Method according to any of the previous subjects, characterized in that the reaction temperature lies between 300″C and 440° C.
(IX) Method according to any of the previous subjects, characterized in that the reaction temperature lies between 350″C and 410° C.
(X) Method according to any of the previous subjects, characterized in that the operative pressure is atmospheric pressure.
(XI) Method according to any of subjects I to IX, characterized in that the operative pressure is lower than atmospheric pressure.
(XII) Method according to any of subjects I to IX, characterized in that the operative pressure is higher than atmospheric pressure.
(XIII) Method according to any of the previous subjects, characterized in that the stabilization of the sump phase at the start of the method is achieved by the use of the crude oil to be processed and/or a heavy oil that is miscible with the crude oil as a starter sump phase.
(XIV) Method according to any of the previous subjects, characterized in that a portion of the sump phase is permanently transferred out during the continuous operation mode.
(XV) Method according to subject XIV, characterized in that the out-transferred sump phase is separated from solid residue.
(XVI) Method according to subject XV, characterized in that the out-transferred sump phase separated from solid residue is reverted into the reactor.
(XVII) Method according to any of the previous subjects, characterized in that the cooling of the released products and the condensation of the vapor portions occur in two stages, characterized in that the first stage is run at a higher temperature and the second stage at a lower temperature, wherein the temperature of both stages respectively is lower than the respective reaction temperature.
(XVIII) Method according to subject XVI, characterized in that the condensate from the first stage is completely or partially reverted into the reactor.
(XIX) Method according to any of subjects I to XVI, characterized in that the cooling of the released products and the condensation of the vapor portions occurs in more than two stages, characterized in that the temperatures of the first to the last stage are gradually reduced, wherein the temperatures of all stages respectively are lower than the respective reaction temperature.
(XX) Method according to subject XIX, characterized in that the condensate from one or more of the stages is completely or partially reverted into the reactor.
(XXI) Method according to any of the previous subjects, characterized in that a stabilizer is added to the crude oil, characterized in that the stabilizer is miscible with the crude oil and increases the boiling point of the mixture in respect to the boiling point of the crude oil.
(XXII) Method according to any of the previous subjects, characterized in that a polymerization inhibitor is added to the crude oil, characterized in that the polymerization inhibitor suppresses polymerization reactions in the sump phase and/or contains radical scavengers.
(XXIII) Method according to any of the previous subjects, characterized in that a carbonization inhibitor is added to the crude oil, characterized in that the carbonization inhibitor suppresses carbonization reactions in the sump phase and/or contains radical scavengers.
(XXIV) Method according to any of the previous subjects, characterized in that the crude oil is a hydrophobic and/or hydrocarbon-containing fluid.
(XXV) Method according to any of the previous subjects, characterized in that the crude oil contains oxygen, nitrogen, sulfur, phosphor and/or halogens as heteroatoms.
(XXVI) Method according to any of the previous subjects, characterized in that the crude oil consists completely or partially of one substance or several substances from the substance groups heavy oils, fats, fatty acids, fatty acid compounds, heteroatom-containing fat soluble substances, tall oils and/or resin acids.
(i) Method according to any of the previous subjects, characterized in that the crude oil consists completely or partially of one substance or several substances from the substance groups bunker oils, oils for metalworking and/or lubricants.
(XXVIII) Method according to any of the previous subjects, characterized in that the crude oil consists completely or partially of one substance or several substances from the substance group triglycerides.
(XXIX) Method according to any of the previous subjects, characterized in that the crude oil consists completely or partially of one substance or several substances from the substance groups vegetable oils, vegetable fats, animal oils, animal fats, algae oils and/or algae lipids.
(XXX) Method according to any of the previous subjects, characterized in that the crude oil consists completely or partially of one substance or several substances from the substance groups fatty acid esters, monoglycerides, diglycerides, phosphatides, glycolipids, diol lipids, waxes and/or sterol esters.
(XXXI) Method according to any of the previous subjects, characterized in that the crude oil consists completely or partially of one substance or several substances from the substance groups sterols, respectively steroid alcohols, tocopherols, tocotrienols and/or colorants such as chlorophyll.
(XXXII) Method according to any of the previous subjects, characterized in that the crude oil consists completely or partially of one substance or several substances from those substance groups listed in subjects XXVI to XXXI, characterized in that this substance or these substances are present in a used state and/or as waste material.
(XXXIII) Method according to any of the previous subjects, characterized in that the crude oil consists completely or partially of waste oil, used fat, fat from fat separators, used lubricant, used motor oil, used bunker oil and/or used oil for metalworking.
(XXXIV) Product oil, generated by a method according to any of the previous subjects.
(XXXV) Product oil, generated by a method according to any of the previous subjects, characterized in that the product oil lies in the light and/or middle oil range.
(XXXVI) Product oil according to subject XXXIV, characterized in that the heteroatom portion in the product oil is lower than in the respective processed crude oil.
(XXXVII) Product oil, characterized in that it is a processed form of a product oil according to any of subjects XXXIII to XXXV.
(XXXVIII) Product oil according to subject XXXVI, characterized in that the processing is obtained by hydrogenation, deoxygenation and/or hydrodeoxygenation.
(XXXIX) Use of a product oil according to any of subjects XXXIII to XXXVII as an additive component and/or additive of a customary product.
(XL) Use of a product oil according to any of subjects XXXIII to XXXVII as a substitute and/or equivalent for a customary product.
(XLI) Use of a product oil according to any of subject XL, characterized in that the customary product is heating oil, petrol, diesel fuel, kerosene fuel and/or aviation fuel.
(XLII) Use of a product oil according to any of subjects XXXIII to XL on triglyceride basis as an additive component and/or additive and/or substitute of diesel fuel.
(XLIII) Use of a product oil according to subject XLII for emission reduction at the combustion in a diesel motor in comparison to pure diesel fuel.
(XLIV) Use of a product oil according to any of subject XLI on triglyceride basis as an additive component and/or additive and/or substitute of kerosene aviation fuel.
(XLV) Use of a product oil according to any of subjects XXXIII to XXXIX as an intermediate product for the processing to fuel components and/or fuel substitute by procedural measures such as hydrogenation, deoxygenation and/or hydrodeoxygenation.
(XLVI) Use of a product oil according to any of subjects XXXIII to XXXIX as platform chemical for chemical and/or pharmaceutical production.

1. A method for the thermal conversion of heteroatom-containing crude oils into low-heteroatom light and/or middle oils, comprising the steps of:
supplying the crude oil into a reactor in which a sump phase is held at reaction temperature,
evaporating the target products in the light and/or middle oil range from the sump phase and of discharging the reactor via the released gas/vapor phase,
cooling the released gas/vapor phase, condensing the vapor portions and separating and discharging the formed condensate, and
discharging the non-condensed gas phase.

2. The method according to claim 1, wherein the method is carried out in a continuous operation mode, permanent crude oil supply and a permanent product out-transfer.

3. The method according to claim 1, wherein the formed condensate is an oil phase consisting of the target products in the light and/or middle oil range.

4. The method according to claim 1, wherein in the condensate additionally to the oil phase an aqueous phase is formed immiscibly separated from the oil phase.

5. The method according to claim 1, wherein the sump phase in the reactor is a heavy oil, and at reaction temperature it is fluid and does not evaporate.

6. The method according to claim 1, wherein the sump phase is stabilized, and the characteristics of the sump phase and/or the characteristics of the products evaporated out of it and/or the characteristics of the released products do not change in the continuous operation mode.

7. The method according to claim 1, wherein the reaction temperature lies between 200° C. and 470° C., preferred between 300° C. and 440° C., particularly preferred between 350″C and 410° C.

8. The method according to claim 1, wherein the operative pressure is atmospheric pressure.

9. The method according to claim 1, wherein the operative pressure is lower or higher than atmospheric pressure.

10. The method according to claim 1, wherein the stabilization of the sump phase at the start of the method is achieved by the use of the crude oil to be processed and/or a heavy oil that is miscible with the crude oil as a starter sump phase.

11. The method according to claim 1, wherein a portion of the sump phase is permanently transferred out during the continuous operation mode.

12. A product oil, generated by a method according to claim 1.

13. The product oil, generated by a method according to claim 1, wherein the product oil lies in the light and/or middle oil range.

14. A use of a product oil according to claim 12 as an additive component and/or additive of a customary product, as a substitute and/or equivalent for heating oil, petrol, diesel fuel, kerosene fuel and/or aviation fuel, or as platform chemical for chemical and/or pharmaceutical production.

15. The method according to claim 7, wherein the reaction temperature lies between 300° C. and 440° C., particularly preferred between 350″C and 410° C.

16. The method according to claim 7, wherein the reaction temperature lies between 350″C and 410° C.
